(19) United States
(12) Patent Application Publication
(10) Pub. No.: US 2018/0340508 A1
(43) Pub. Date: Nov. 29, 2018

(54) DRAG REDUCTION METHOD FOR HYDROKINETIC VERTICAL AXIS TURBINE BLADES AND STRUCTURES

(71) Applicant: POWER DEVELOPMENT INTERNATIONAL, INC., FRAMINGHAM, MA (US)

(72) Inventor: Kahoru Watanabe, Sarasota, FL (US)

(73) Assignee: POWER DEVELOPMENT INTERNATIONAL, INC., FRAMINGHAM, MA (US)

(21) Appl. No.: 15/986,058

(22) Filed: May 22, 2018

Related U.S. Application Data
(60) Provisional application No. 62/509,893, filed on May 23, 2017.

(51) Int. Cl. F03B 3/14; F03B 17/06; F03B 13/26

(52) U.S. Cl. CPC F03B 3/145; F03B 17/063; F05B 2250/71; F05B 2240/932; F03B 13/264

(57) ABSTRACT

A vertical axis turbine includes a vertical rotary shaft and turbine blades mechanically coupled to the vertical rotary shaft, each of the turbine blades including curved rounded physical geometries on a leading edge. A method of reducing drag includes improving lift over an air foil design using curved rounded physical geometries on a leading edge of hydrokinetic vertical axis blades that produce channels of high and low pressure water flows over a surface of the hydrokinetic vertical axis blades.

### CROSS REFERENCE TO RELATED APPLICATIONS

This application claims benefit from U.S. Provisional Patent Application Ser. No. 62/509,893, filed May 23, 2017, which is incorporated by reference in its entirety.

### STATEMENT REGARDING GOVERNMENT INTEREST

None.

### BACKGROUND OF THE INVENTION

The present invention relates generally to energy systems, and more particularly to is a drag reduction method for hydrokinetic vertical axis turbine blades and structures.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a method of reducing drag including improving lift over an air foil design using curved rounded physical geometries on a leading edge of hydrokinetic vertical axis blades that produce channels of high and low pressure water flows over a surface of the hydrokinetic vertical axis blades.

In another aspect, the invention features a vertical axis turbine including a vertical rotary shaft and turbine blades mechanically coupled to the vertical rotary shaft, each of the turbine blades including curved rounded physical geometries on a leading edge.

In another aspect, the invention features a system including blades rotating about a vertical axis, each of the of blades including a leading edge and a trailing edge, the leading edge including curved rounded physical geometries that produce channels of high and low pressure flows over a surface of the blade.

In another aspect, the invention features a hydrokinetic turbine including a rotor including a hub and blades, each of the plurality of blades having a leading edge and a trailing edge, the leading edge having curved rounded physical geometries that produce channels of high and low pressure flows over a surface of the blade, a drive train, a generator, and a mounting structure.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 Is a perspective, illustrative view of a CFD (Computational Fluid Dynamics) showing a difference between the flow off a symmetrical NACA air foil (right) and the tubercle like physical geometries air foil (left).

FIG. 2A shows an illustrative side view image of a blade of present invention and an above view of its vertical rotation.

FIG. 2B shows an exemplary image of a blade developed under the prior art Dewar, Watts, Fish patent and a side view illustration of its horizontal rotation pattern as applied.

FIG. 2C shows an illustrative perspective image of a whale tubercle inspired blade as applied in horizontal wind blades and in propellers.

FIG. 2D shows an illustrative side image of the blade profile of this invention FIGS. 2D-1 and 10 the blade profile as illustrated in the FIG. 2D-2.

FIG. 2E are illustrative side images showing the differences of the lift forces on the blades of FIG. 2D as previously published.

FIG. 2F is a data chart from prior art Patent US20130028742—FIG. 4 which is a performance comparison of a lift based blade compared to a symmetrical blade in a vertical axis application.

FIG. 2G shows a perspective image FIG. 2G-1 from the prior art Dewar, Watts, Fish patent and a similar perspective image FIG. 2G-2 showing the blade of this invention.

FIG. 3 Shows an illustrative side and above view of the blades of this invention with “winglets.”

FIG. 4A is an illustrative above view of a high torque self-shaping blade and a secondary 20 illustration showing an above image of its rotation.

FIG. 4B is an illustrative side view of a high torque self-shaping blade showing the counterclockwise rotations within the cavities of the blade.

FIG. 4C is an illustrative side view of a high torque self-shaping blade with curved rounded physical geometries evenly located across the leading edge across its length.

FIG. 5A is a perspective illustration of a symmetrical NACA air foil.

FIG. 5B is an illustrative above view of a NACA foil being fitted by curved rounded physical geometric retrofit parts.

FIG. 5C is an above view illustration of a symmetrical NACA air foil with a retrofit sleeve with curved rounded physical geometries evenly spaced across the length of the part.

FIG. 5D shows a side illustration of the sleeve fitting over the NACA air foil.

FIG. 6 shows a perspective illustration of one embodiment of a hydrokinetic vertical axis turbine identifying some structural parts in the water where retrofit curved rounded physical geometries could be applied.

FIG. 7A shows a perspective illustration of a hydrokinetic vertical axis turbine on a floating platform which has not been deployed in the water.

FIG. 7B shows a perspective illustration of a hydrokinetic vertical axis turbine on a floating platform in its deployed position in the water.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

The present invention relates to reducing drag, improving performance by integrating curved physical geometries on the leading edge of hydrokinetic vertical axis blades and structures. These produce intermittent channels of high and low pressure water flows over the surface of the blades which reduces drag. One embodiment of the present invention is to design the blade with evenly placed curved physical geometries along the leading edge of the blade, in an organized symmetrical pattern, distributed evenly across the length. These will produce evenly distributed areas of high and low pressure across the surface length of the blade, reducing drag across the blade and turbulence at the end tips of the blade. This invention has also contemplated reducing turbulence at the end of the blade by capping the ends of the blade using winglets which can stabilize the water flowing across the ends. Reducing turbulence at the ends of wings in aviation has produced as much as 7% overall drag reduction. A blade design which has a high torque self-shaping characteristic, using virtual shaping to seal its open cavity, and can be used by itself or combined with the curved, rounded physical geometries of this application, which can virtually shape itself for better performance. The self-starting characteristic is propelled by its drag powered Savonius design and the virtual shaping occurs as the rotation accelerates, sealing the open cavities, which turn the blade into a lift powered Darrius type blade which define its hybrid characteristics. A blade design(s) whose ability to expand its functionality during its rotation by nearly 50% over state of the art symmetrical U.S. National Advisory Committee for Aeronautics (NACA) air foil designs. A blade design, in one embodiment, whose curved rounded physical geometries evenly spaced along the leading edge, that can be built into new blades, or can be made as a retrofit feature to existing blades. Curved, rounded physical geometries which can be built into static non-moving structural support parts of an HVAT for fixed or floating platforms (underneath or sides support structures designed to stabilize and or to reduce stress forces on them, allowing for a lighter unit using less materials. Curved, rounded physical geometries which can be built into other rotating or moving parts such as support arms for the rotating blades. The application of the designs in this application can also be integrated into vertical axis wind turbines.

In should be noted that the design features of the prsent invention may be applied to support structures of any system that operates in a water environment and is not limited to power producing vertical and horizontal turbines—they can be applied to any structure which experiences resistance forces resulting from water flow.

As horizontal rotating blades are attached at a central point, they do not have rotating support arms as found in vertical axis turbines, which are the focus of this invention. The application of the curved rounded physical geometries of this invention when applied to the leading edge of rotating arms further reduces drag forces.

Similar drag reduction can be accomplished through the strategic application of these curved rounded physical geometric features along the leading edge of static components which may include supporting structures or frames required to support the rotating system. For the purposes of this invention, the leading edge is defined as the area of any component that is the primary impact point for the oncoming flow as explained in the figures of this application. Through the separation of the water flow into consecutive channels of high pressure and low pressure, drag is reduced on the overall blade, improving rotation speed, lift and efficiency.

The focus of the present invention as applied to turbine blades are intended specifically for vertical axis rotating applications, which have unique rotation, pressure and flow characteristics when compared to state of the art horizontally rotating turbine blades. The prior art Dewar, Watts, Fish patent (US 2009/0074578) published on Mar. 19, 2009 design may be applied successfully to horizontally rotating blades, but not vertically rotating axis turbines, which is where this application focuses on differentiating itself from the prior art Dewar, Watts, Fish patent and establish the uniqueness of this invention. The application of this invention also integrates multiple innovations that extend beyond what has been previously considered in more conventional terms by the prior art Dewar, Watts, Fish patent and others.

Scientists and entrepreneurs have been trying to advance the technology of smaller scale modular hydrokinetic vertical and horizontal turbines for several decades now, from tidal applications to river and canal focused designs. The main advantages of these simplified power generating systems is that costly and time consuming infrastructure such as dams, alternate navigation canals for boats and fish mitigation devices are not required. Environmental impact studies are greatly reduced, accelerating the permitting and thus approval period, while dramatically improving the profitability for power developers without which innovation would have little meaning. The applications for this technology for use in micro-grids or in mobile applications such as for military or disaster relief are numerous, particularly when these systems are attached to floating platforms. The designs can also be easily adopted for easier lower cost installations by leveraging existing canal wall infrastructure or tailraces of existing dam structures.

In West Africa alone, the potential from small water projects using technology such as ours exceeds 1.9 TW which could efficiently be put into place without the need for costly infrastructural utility lines. This ability to produce and distribute power locally where small hydro resources are ample is disruptive in both cost and time.

The current challenges facing the HVAT industry is the need to improve the efficiency of its rotating blades, which in average velocity environments flows between 1-1.5 m/s. The challenge in producing power in this type of velocity is the need for larger blades, more support structure and the need to generate sufficient rotation without exceeding the limitations created by the rotating diameter needed to provide sufficient torque. Current state of the art blades used in HVAT are simple symmetrical NACA blades, which offer the best-known efficiencies for these platforms. Studies have shown that using the designs of this invention, we could improve performance by 30% in drag reduction and improvements in performance by increasing the range of angle of attack by nearly 50%.

The increase in the range of effective angle of attack is critical in reducing the impact or even eliminating the impacts of stall, which reduce rotation efficiency. Previous testing has shown that in a vertical rotating configuration, that symmetrical blades outperform lift inducing or lift oriented blade designs by over 50%. This level of improvement is what would be necessary to disrupt HVAT design sufficiently enough to allow manufacturers of these systems to reduce blade length and size, reduce rotor lengths and rotation dimensions exponentially to achieve superior performance, while reducing costs.

In another embodiment of this application for the blades in this invention, a high torque faster starting design has also been contemplated, which can be integrated with curved physical geometries on the leading edge and would have unique self-starting and self-shaping characteristics designed on the trailing edge. The resulting system have a hybrid performance which begins rotation as a Savonius 20 (drag) blade and as it accelerates, transforms into a Darrius lift based blade. For maximum performance, this blade would also have a symmetrical profile along the chord line.

Currently there are no other known applications of the inventions in this application in the hydrokinetic industry. All are known to use either the symmetrical NACA foil, or traditional horizontal type blades being used in the wind turbine industry. Similarly, the self-starting blade design using Savonius blade characteristics combined with the virtual shaping aspects, as contemplated in this application have yet to be applied in a hydro environment. Virtual shaping has been applied in vertical axis wind turbines blades, such as those described in US 2013/0028742 (Watanabe), but the forces required to survive a hydro environment would preclude the application of that design. Additionally, the Watanabe patent does not contemplate the use of drag reducing curved, rounded physical geometries on the leading edge. The most relevant conclusion of the Watanabe patent is the study which showed that symmetrically shaped air foils far exceed the performance of lift oriented blade designs, which suffered from stalling in vertical axis rotations.

In conclusion, this application highlights the clear differences between the Dewar, Watts, Fish patent for horizontal wind or hydro turbine blade applications in US 2009/0074578 published on Mar. 19, 2009. Their contemplated application is applicable to and through their patent figures and descriptions, demonstrate a focus which is effective on horizontally rotating applications. This application will demonstrate that hydro-kinetic applications in vertical axis rotating systems have substantially different design requirements due to the different fluid characteristics present in moving water, which is a focus of this invention. Several direct references will be made to the prior art Dewar, Watts, Fish patent for the purposes of highlighting the differences between the innovations. Although their application references in very general terms a broad application in a hydro/water environments, the reality is that they have designed a system with characteristics that only fundamentally apply to horizontally rotating systems.

The importance in the differences between the performance of symmetrical and lift type blades in a vertical axis turbine configuration cannot be underestimated and has also been the focus of this application. The applicant of this invention has through actual data determined that a lift based blade design in a vertical axis configuration leads to stalling and inefficiency not experienced by symmetrical blade.

Finally, although this application focuses on hydro-kinetic vertical axis turbines, it may also be equally applied to vertical axis wind turbine designs.

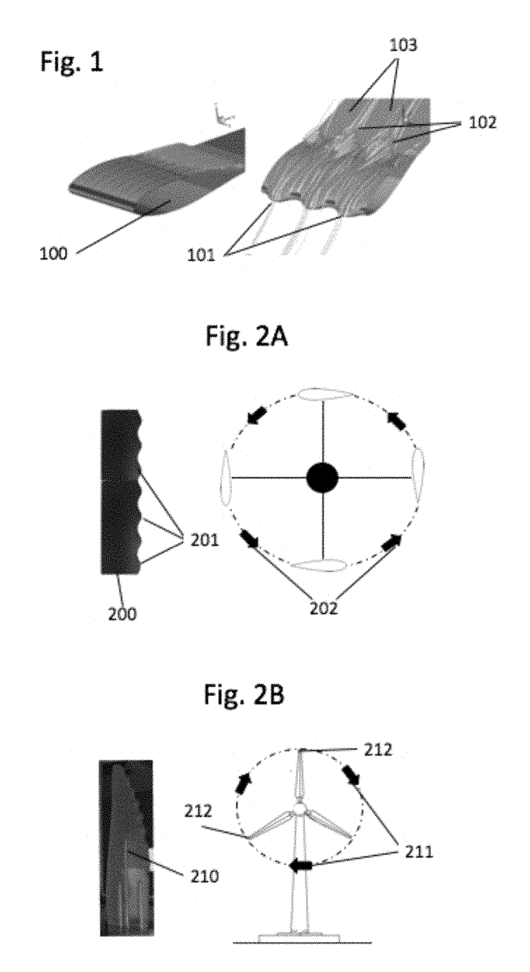

Referring now to FIG. 1, the present invention relates to reducing drag, improving lift over conventional air foil 100 designs using curved rounded physical geometries 101, on the leading edge of hydrokinetic vertical axis blades which produce channels of high 102 and low 103 pressure water flows over the surface of the blades, which has proven to reduce drag.

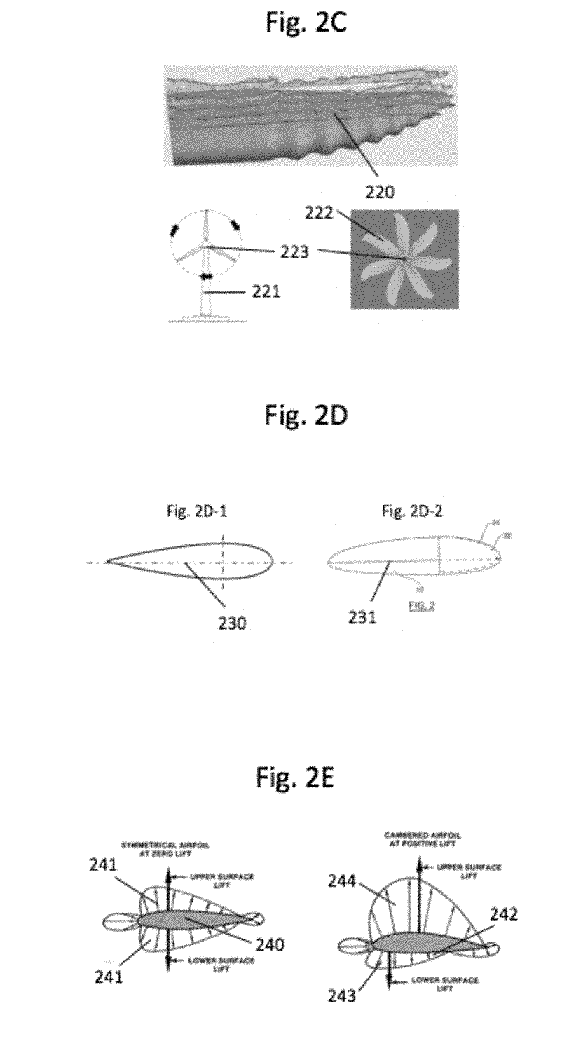

In FIG. 2A, the image shows the symmetrical blade 200 with even placement of the curved physical geometries 201 across the entire length of the blade with an even width foil across the entire length, which is required for its vertical rotation 202 pattern. Forces in a vertical axis rotation tend to be equally distributed across the length of the blade, which is in sharp contrast to horizontal axis rotations.

Referring to FIG. 2B, in contrast to FIG. 2A, the design has an uneven width in this horizontal axis blade 210 as contemplated in the prior art Dewar, Watts, Fish patent. Due to its rotation pattern and uneven width, 211 has unequal forces running across the length of its rotation as the forces tend to push air outward towards the tips of the blades 212.

In FIG. 2C, the image shows the design and shape of an optimized blade 220 as contemplated in the prior art Dewar, Watts, Fish patent. This is exclusive to horizontal applications such as horizontal wind turbines 221, propellers 222 or helicopter rotors, where there is a fixed point or center of rotation 223, required to provide consistent lift.

As shown in FIG. 2D-1, the symmetrical profile as evidenced by the chord line 230 of the blade 10 of this invention, whose goal is to minimize lift as it rotates around the center as seen in FIG. 2A.

FIG. 2D-2 is a similar side view of the prior art Dewar, Watts, Fish patent, which is an asymmetrical designed blade to maximize lift at every angle as evidenced by its chord line 231.

In FIG. 2E, the symmetrical airfoil 240 used in this invention reduces the lift forces away from the center of rotation, as it rotates per FIG. 2A. The balanced forces on both sides of the blade 241 reduce stall in a vertical axis rotation. This is in stark contrast to the lift based forces acting on the cambered foil 242 of the prior art Dewar, Watts, Fish patent, which has lower pressure on the bottom side of the blade 243 versus the upper side of the blade 244, thus creating positive lift, which in a horizontal application is a fixed angle during rotation, which is the focus of their patent.

FIG. 2F illustrates the resulting data which compared the performance of a lift based blade to a 20 symmetrical blade in a vertical axis wind turbine application. The only difference between the blades were the foil types, operating in similar wind conditions 250. 251 is a lift based foil FIG. 2D-2 with the characteristics of FIG. 2E cambered foil of the prior art Dewar, Watt, Fish patent compared to the symmetrical foil 252 of this present invention. It was clear from these results that when applied to a vertical axis rotation that a lift based cambered design does not perform efficiently in comparable operating conditions, suffering from frequent stalling at lower speeds.

FIG. 2G-1 is selected from the prior art FIG. 1A of the prior art Dewar, Watts, Fish patent and describes hollow cavities using D-Spar support (e.g., 20 in the patent) 260 to strengthen the blades for their applications.

FIG. 2G-2 which is the blade shape of the present invention, shows the that the center of the blade 261 as solid, regardless of the material composition used to create a solid unit. The D-Spar designs as contemplated by prior art Dewar, Watts, Fish patent would not survive the forces present in a water environment.

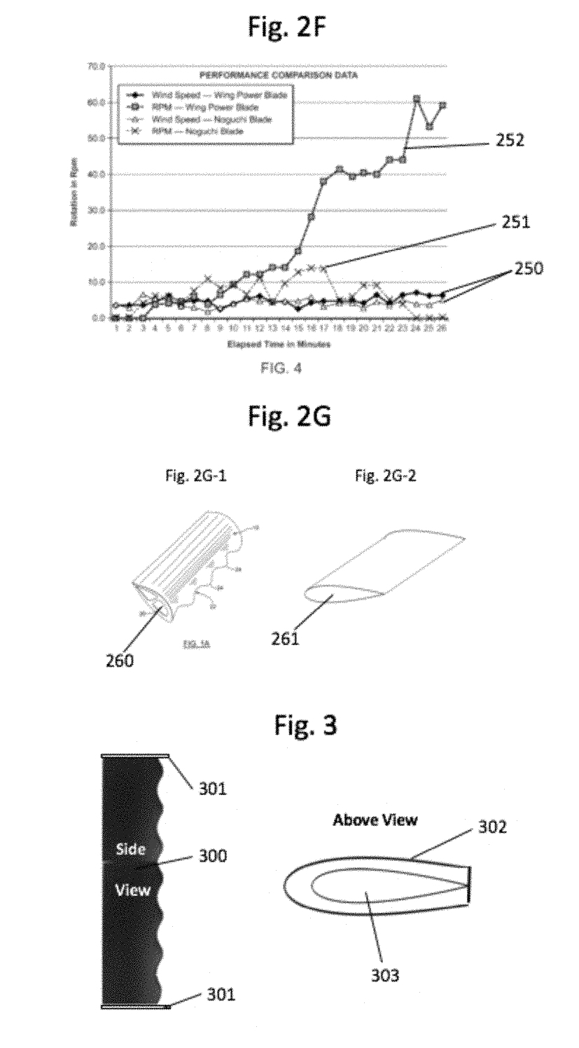

In FIG. 3 the position of the winglets in the side view of a vertical axis blade 300 show the position of the winglets to minimize tip related turbulence on both the top and bottom 301 in strong contrast to the prior art Dewar, Watts, Fish patent FIG. 2B which clearly still anticipates substantial and uneven flow near the outside tips ends. The winglets shape 302 is demonstrative only and shows the plate must extend beyond the profile of the blade 303 it is containing.

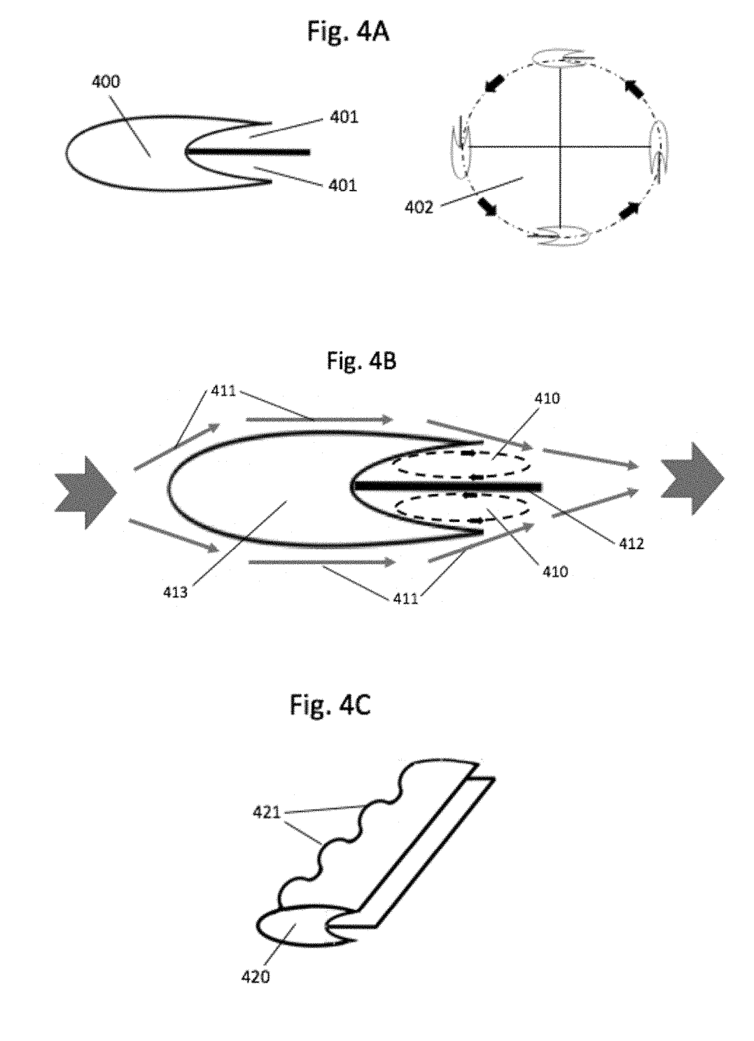

In FIG. 4A, this blade design 400 uses virtual shaping to seal its open cavities 401, which are designed to use drag to increase start-up torque and can be used with a symmetrical NACA air foil 10 profile. This can be combined with the curved physical geometries that are spaced evenly across the length of the blade as illustrated in FIG. 4B and is for application in vertical axis rotating 402 hydrokinetic turbines. This design can also be applied to vertical axis wind turbines.

In FIG. 4B, the virtual shaping in the cavities of the blade are the result of the rotating water in the cavities 410 are created by the natural water flows 411 that occur around the blade. In this embodiment, the rotations run counterclockwise to each other, which is caused by the separation 412 built into the blade 413. The rotations create virtual shaping so that the water flow going around the cavity sees a solid object once it achieves a certain velocity of rotation. It is possible that more than one rotation is occurring within each part of the separation. Previous studies have shown that one or multiple rotations may occur within each cavity. 20

In FIG. 4C, the combination of the blade design 420 of FIG. 4A with the curved rounded physical geometries 421 of FIG. 2A is designed to create a high torque self-starting rotation, while taking advantage of the increased range of angle of attack. The separation of the water into channels of high and low pressure may also be mimicked by the rotating vortices within the cavity and trailing edge 422 of this blade, as it shapes itself to adjust to the changes in pressure, which would add to its overall efficiency.

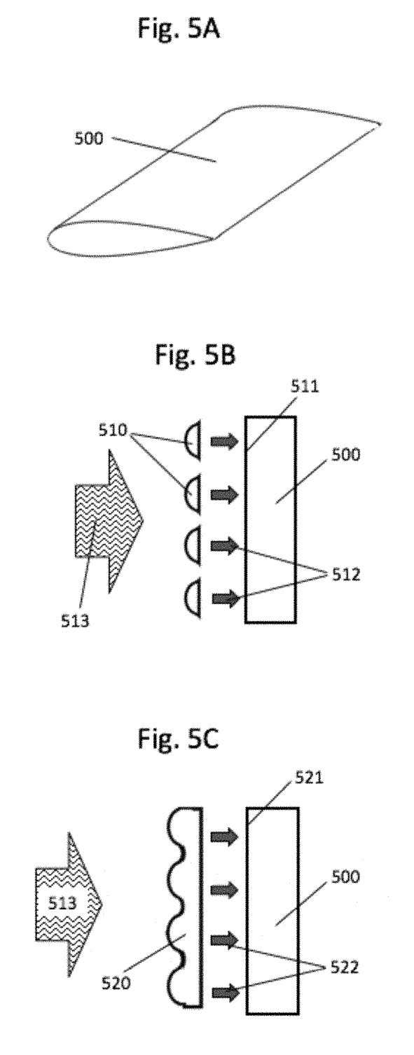

FIG. 5A shows a perspective view of a state of the art symmetrical NACA air foil blade 500 for use in a vertical axis turbine in both hydro and wind applications.

FIG. 5B shows the same foil 500 as now seen from an above view with individual curved physical geometric shapes that are spaced evenly across the length of the blade 510 being attached 511 to the leading edge of the blade 512 along the entire length of the blade. The arrow shows the direction of the oncoming flow 513.

FIG. 5C shows an above view illustration of a symmetrical NACA air foil blade 500 with a retrofit sleeve with curved physical geometric shapes spaced evenly across the length of the blade 520 being fitted onto 521 the leading edge of the blade 522. The arrow shows the direction of the oncoming flow 513.

FIG. 5D shows a side illustration of the same symmetrical blade 500 with the retrofit sleeve 530 fitting over the NACA air foil which would then be attached 531 to the leading edge of the blade 532 and can be replaced as required or to retrofit future improved embodiments.

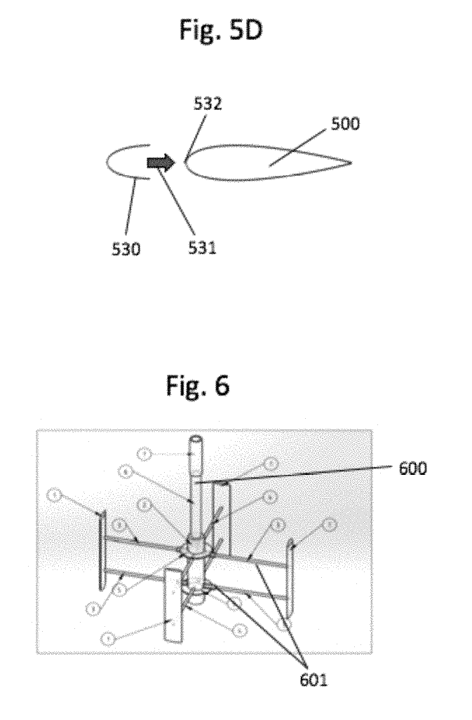

FIG. 6 identifies static and rotating structural parts for a hydro vertical axis turbine, where prefabricated or retrofit curved rounded physical geometries that are spaced evenly across the length of the blade of FIGS. 5B and 5C could be applied. Static structures such as the drive shaft sleeve 600 or the arms that support the blades 601 are potential areas of application. This type of application can help stabilize and or reduce structural forces on them which could potentially reduce materials used. Since water is constantly moving against and around the static parts, these features can still be effective in this type of application.

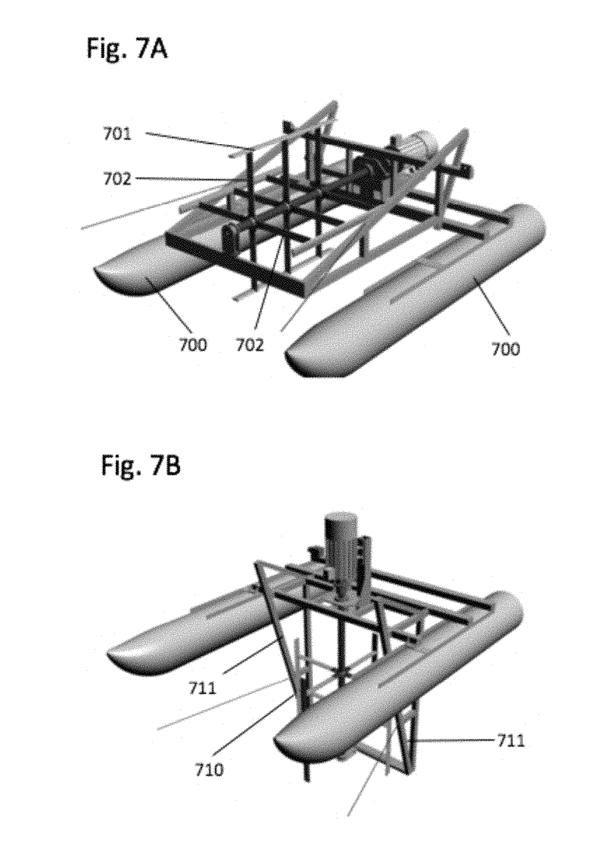

FIG. 7A shows a perspective illustration of a hydrokinetic vertical axis turbine on a floating platform which is supported by floats 700 and the blades 701 are supported by arms 702. The arms 702 are areas where retrofit or built in curved rounded physical geometries evenly spaced across the length 20 of the leading edge of the blade could be added to reduce drag and improve performance.

FIG. 7B shows a perspective illustration of a hydrokinetic vertical axis turbine on a floating platform showing the blades 710 in its deployed position in the water. In this embodiment, the floating unit has a physical structure 711 which supports the system in the water. Since the structure 711 is also subject to flow resistance, the curved rounded physical geometries evenly spaced across the length could be built into its design or added as a retrofit feature.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

What is claimed is:

1. A method of reducing drag comprising:
improving lift over an air foil design using curved rounded physical geometries on a leading edge of hydrokinetic vertical axis blades that produce channels of high and low pressure water flows over a surface of the hydrokinetic vertical axis blades.

2. The method of claim 1 further comprising positioning winglets on the hydrokinetic vertical axis blades to minimize tip related turbulence on a top and a bottom of the blades.

3. The method of claim 1 wherein the curved physical geometries are spaced evenly across a length of the leading edge of hydrokinetic vertical axis blades.

4. The method of claim 1 wherein the curved physical geometries are cavities.

5. The method of claim 1 where curved rounded physical geometries comprise a sleeve configured to fit over the leading edge of hydrokinetic vertical axis blades.

6. A vertical axis turbine comprising:
a vertical rotary shaft; and
a plurality of turbine blades mechanically coupled to the vertical rotary shaft, each of the turbine blades comprising curved rounded physical geometries on a leading edge.

7. The vertical axis turbine of claim 6 further comprising a hydraulic energy storage apparatus coupled to the vertical rotary shaft.

8. The of claim 6 wherein the curved physical geometries are spaced evenly across a length of the leading edge of the turbine blades.

9. A system comprising:
a plurality of blades rotating about a vertical axis, each of the plurality of blades comprising a leading edge and a trailing edge, the leading edge comprising curved rounded physical geometries that produce channels of high and low pressure flows over a surface of the blade.

10. The system of claim 9 wherein the curved physical geometries are spaced evenly across a length of the leading edge of the blades.

11. A hydrokinetic turbine comprising:
a rotor comprising a hub and plurality of blades, each of the plurality of blades comprising a leading edge and a trailing edge, the leading edge comprising curved rounded physical geometries that produce channels of high and low pressure flows over a surface of the blade;
a drive train;
a generator; and
a mounting structure.

12. The hydrokinetic turbine of claim 11 wherein the drive train comprises:
a low speed shaft;
a gearbox;
a high speed shaft; and
support bearings.

13. The hydrokinetic turbine of claim 11 wherein the generator transforms mechanical energy from the rotor to electrical energy.
